(19) United States
(12) Patent Application Publication
(10) Pub. No.: US 2005/0163214 A1
(43) Pub. Date: Jul. 28, 2005

(54) Image recompressing apparatus and image recompressing method

(75) Inventor: Shoji Yachida, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/040,777

(22) Filed: Jan. 21, 2005

(30) Foreign Application Priority Data
Jan. 23, 2004 (JP) 015987/2004

(51) Int. Cl. H04N 7/12

(52) U.S. Cl. 375/240.03; 375/240.2

(57) ABSTRACT

An image recompressing apparatus includes header information separating means for separating header information and compressed image information from compressed image data obtained by decoding, inverse quantizing means for performing inverse quantization of compressed image information depending upon a quantization matrix and a quantization scale code in the separated header information, quantization matrix transforming means for changing the quantization matrix according to a predetermined compressibility factor, quantization scale code transforming means for changing the quantization scale code according to the compressibility factor, and quantizing means for requantizing the inverse quantized image information depending upon the post-transformation matrix and the post-transformation quantization scale code. Thus, in the transformation of an amount of code of compressed/encoded time-varying image data, it is possible to realize the function of preventing degradation in image quality while reducing an amount of code in a high speed.

### BACKGROUND OF THE INVENTION

1. Field of the Invention

The present invention relates to an image recompressing apparatus and an image recompressing method for transforming an amount of code in a compressed image stream.

2. Description of the Related Art

As disclosed in the cited references, two methods are conventionally known for transforming an amount of code of compressed/encoded time-varying image data. In the cited reference 1 (see paragraph 0009 and FIG. 1 of Japanese Patent No. 3085024), variable length decoding is made to the compressed/encoded time-varying image data. After the inverse quantization, the time-varying image data is subsequently requantized with a changed quantization coefficient so as to obtain a desired amount of code. Thus, the amount of code can be transformed after the second variable length encoding. On the other hand, in the cited reference 2 (see paragraphs 0011 to 0014 of Japanese Patent Application Laid-Open No. 2003-87796), a compressed time-varying image is expanded, and is recompressed by directly using original encoding parameters of the compressed time-varying image, resulting in prevention of a loss in image quality.

The method disclosed in the cited reference 1 is most effective for transformation of the amount of code of the compressed/encoded image data. That is, the recompression without discrete cosine transformation (DCT) can reduce the amount of code in a shorter time interval than a real time required for image display. However, the main purpose of the method is limited to the reduction of the amount of code. The cited reference 1 discusses no method for prevention of loss in image quality. In addition, the prevention of loss in image quality inevitably requires an inverse DCT as disclosed in the cited reference 2. Even if the amount of code can be reduced in a high speed, the speed is limited by the inverse DCT.

### SUMMARY OF THE INVENTION

In view of the foregoing problems, it is an object of the present invention to provide an image recompressing apparatus and an image recompressing method, which can implement the function of preventing degradation in image quality while reducing an amount of code in a high speed in transformation of the amount of code of compressed/encoded time-varying image data stored in a home server, a hard disk recorder, and so forth, resulting in a more significant advantage for a user.

According to the present invention, for achieving the above-mentioned objects, there is provided an image recompressing apparatus including variable length decoding and header information separating means for separating compressed/encoded image data into DCT coefficient (compressed image information) and other parameters such as header information, inverse quantizing means for performing inverse quantization of the separated DCT coefficient depending upon a quantization matrix and a quantization scale code extracted from the header information, image complexity operating means for finding image complexity (X value) without expansion into base band image data, quantization matrix transforming means for extracting the quantization matrix from the compressed/encoded data, and properly performing weighting to reduce higher frequency components in the DCT coefficient according to complexity of the encoded input image, quantization scale code transforming means for making a control to obtain a desired amount of code according to the input quantization scale, quantizing means for requantizing the inverse-quantized DCT coefficient, header information adding means for adding the header information to the requantized DCT coefficient in the order defined in a compressing/coding method, and variable length encoding means for performing variable length encoding such as Huffman coding. In the apparatus, it is possible to carry out recompressing/coding in a high speed, and simultaneously control an amount of code by utilizing a feature of image data, thereby preventing degradation in image quality. Thus, according to the present invention, in order to reduce the amount of code of compressed time-varying image data, recompression is made to the compressed time-varying image data with the original DCT coefficient. In this operation, complexity of the image is calculated, and weighting is made to the quantization matrix according to the complexity. It is thereby possible to transform the amount of code at a high speed, and reduce degradation in image quality.

Consequently, according to the present invention, in transformation of a bit rate of the compressed image, re-encoding can be made before the encoded data is completely decoded, thereby enhancing a bit rate transforming speed. Further, the quantization matrix can be selected according to the complexity of image, and the quantization scale weighted according to the picture type can be selected, resulting in reduction of error propagation. Furthermore, redundant header or data is deleted to provide the effect of preventing deterioration in image quality.

### BRIEF DESCRIPTION OF THE DRAWINGS

The foregoing and other objects, aspects and advantages will be better understood from the following detailed description of preferred embodiments of the invention with reference to the following drawings:

FIG. 1 is a block diagram showing the first configuration of an image recompressing apparatus according to the preferred embodiments;

FIG. 2 is a block diagram showing the second configuration of an image recompressing apparatus according to the preferred embodiments; and

FIG. 3 is a block diagram showing the third configuration of an image recompressing apparatus according to the preferred embodiments.

### DESCRIPTION OF THE PREFERRED EMBODIMENTS

### Embodiment 1

Preferred embodiments of the invention will now be described in detail referring to the accompanying drawings.

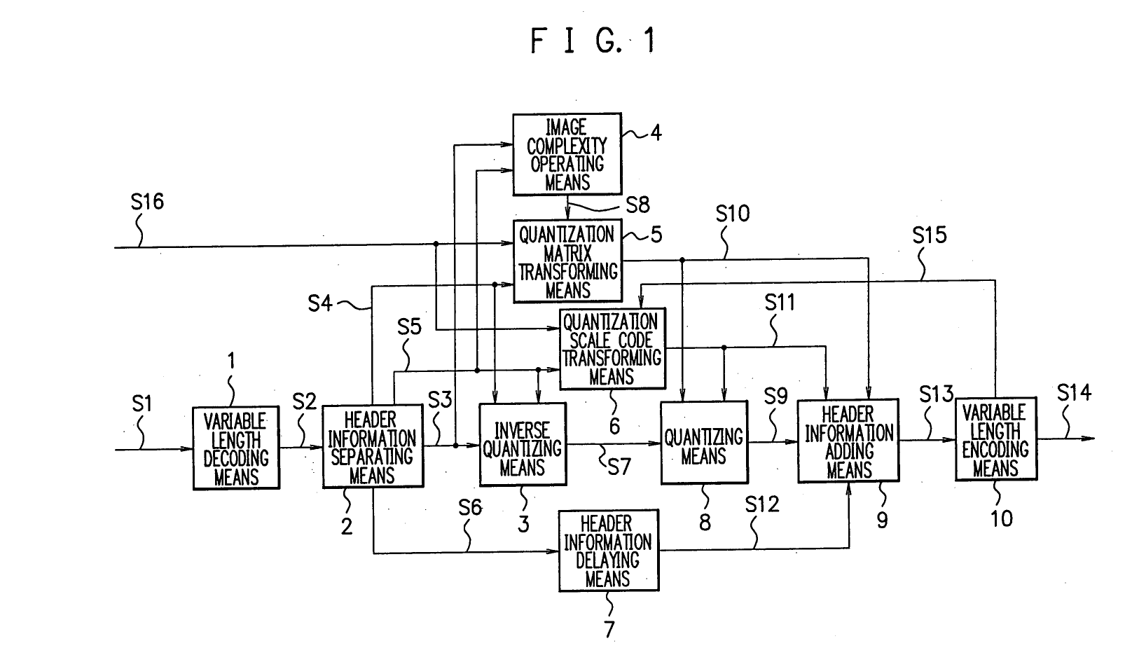

FIG. 1 is a block diagram showing a configuration of an image recompressing apparatus according to the first embodiment of the present invention. In the configuration of FIG. 1, a compressed/encoded image data S1 is, for example, image data obtained by compressing/coding according to MPEG 2 (Moving Picture Expert Group Phase 2) Coding defined in ISO/IEC13818-2, and is input into a variable length decoding means 1. The variable length decoding means 1 decodes the variable length encoded data to output a result as decoded data S2 to a header information separating means 2.

The header information separating means 2 separates from the decoded data S2 DCT coefficient data S3, quantization matrix data S4, quantization scale code data S5, and other header information data S6, thereafter outputting those data respectively to an inverse quantizing means 3, an image complexity operating means 4, a quantization matrix transforming means 5, a quantization scale code transforming means 6, and a header information delaying means 7.

The inverse quantizing means 3 multiplies the DCT coefficient data S3 by the quantization matrix data S4 and quantization scale data obtained by transformation of the quantization scale code data S5, resulting in producing and outputting DCT coefficient S7.

The image complexity operating means 4 multiplies by the quantization scale code data S5 a data size of the DCT coefficient data S3 in macro blocks, thereby producing and outputting image complexity information S8.

Depending upon the image complexity information S8 and a predetermined compressibility factor S16, the quantization matrix transforming means 5 changes the input quantization matrix data S4 to output the result as requantization matrix data S10. In this operation, weighting is carried out such that the requantization matrix data S10 can take a larger value proportional to a higher frequency component of the quantization matrix data S4 in a DCT coefficient field. Further, the predetermined compressibility factor S16 may be set by a user, or may be set depending upon conditions inside the apparatus. For example, the following calculation can be employed to set the condition in the apparatus. That is, when the post-transformation compressed/encoded data is recorded onto a DVD, it is essential to reduce the amount of data to 4.7 gigabytes or less. Therefore, the compressibility factor may be calculated depending upon data size of the compressed/encoded image data S1 and the data capacity of the DVD.

The quantization scale code transforming means 6 performs operations depending upon the quantization scale code data S5 and post-recompression output data bulk information S15 to provide the predetermined compressibility factor S16, thereby outputting requantization scale code data S11.

The header information delaying means 7 delays the header information required for decoding through a delaying means which can delay the header information by a time period required for the inverse quantization or the quantization of the DCT coefficient, and outputs the result as header information S12 required for recompression.

A quantizing means 8 divides the DCT coefficient data S7 by both the requantization matrix data S10 and the requantization scale code data S11 to create and output requantized DCT coefficient data S9.

A header information adding means 9 rearranges according to an MPEG 2 Coding format the requantized DCT coefficient data S9, the requantization matrix data S10, the requantization scale code data S11 and the header information S12 required for recompression, resulting in producing and outputting data S13. A variable length encoding means 10 carries out variable length encoding to output the result as MPEG 2 stream data S14, and calculates and outputs the output data bulk information S15.

Meanwhile, respective means shown in FIG. 1 can be realized in a computer. That is, a central processing unit (CPU) in the computer may perform operations according to programs corresponding to the respective means, thereby realizing an image recompressing apparatus.

A description will now be given of the operations of the present invention referring to FIG. 1. In the first embodiment, the compressed/encoded image data S1 is, for example, the image data obtained by the compressing/coding according to the MPEG 2 Coding defined in ISO/IEC13818-2, and is input into the variable length decoding means 1. The variable length decoding means 1 decodes the variable length encoded data to output the result as the decoded data S2 to the header information separating means 2.

The header information separating means 2 separates from the decoded data S2 the DCT coefficient data S3, the quantization matrix data S4, the quantization scale code data S5, and the other header information data S6, thereafter outputting those data respectively to the inverse quantizing means 3, the image complexity operating means 4, the quantization matrix transforming means 5, the quantization scale code transforming means 6, and the header information delaying means 7. In this case, the variable length decoding means 1 and the header information separating means 2 may integrally be provided as one block because the two means are closely related to each other in the MPEG 2 decoding operation.

The inverse quantizing means 3 multiplies the DCT coefficient data S3 by the quantization matrix data S4 and the quantization scale data obtained by the transformation of the quantization scale code data S5, resulting in producing and outputting the DCT coefficient data S7.

The image complexity operating means 4 multiplies by the quantization scale data obtained by the transformation of the quantization scale code data S5 the data size of the DCT coefficient data S3 in macro blocks, thereby producing and outputting the image complexity information S8. The image complexity information is generally designated as an X value in the MPEG 2.

Depending upon the image complexity information S8 and the predetermined compressibility factor S16, the quantization matrix transforming means 5 changes the input quantization matrix data S4 to output the result as the requantization matrix data S10. In this operation, the weighting is carried out such that the requantization matrix data S10 takes a larger value proportional to the increase of a frequency component value of the quantization matrix data S4 in the DCT coefficient field. Further, a weighting factor may be set to a greater value according to the image complexity information S8 and the compressibility factor S16. This can provide an effect that the higher component can be reduced in advance. It is thereby possible to effectively reduce compression strain even when a more complex image is input.

Further, the predetermined compressibility factor S16 may be set by the user, or may be set depending upon the conditions inside the apparatus. As set forth above, for example, the following calculation can be carried out to set the condition in the apparatus. That is, when the post-transformation compressed/encoded data is recorded onto the DVD, it is essential to reduce the amount of data to 4.7 gigabytes or less. Therefore, the compressibility factor may be calculated depending upon the data size of the compressed/encoded image data S1 and the data capacity of the DVD. In addition, when the predetermined compressibility factor S16 is fixed, any external input data is not necessary. That is, the compressibility factor S16 may be preset in the quantization matrix transforming means 5 and the quantization scale code transforming means 6.

Further, the predetermined compressibility factor shows the ratio between a bit rate or an amount of code of the input compressed/encoded data and a bit rate or an amount of code of post-recompression compressed/encoded data. Hence, instead of giving the compressibility factor from outside, an additional means may be employed for detecting the bit rate described in the input compressed/encoded data. As a result, the same function can be provided by externally determining the bit rate or the amount of code of the post-recompression compressed/encoded data. In addition, the compressibility factor S16 may be changed in a GOP (Group Of Picture) unit serving as the minimum unit.

Further, when the quantization matrix transforming means 5 changes the weighting according to the image complexity information S8, the original image complexity information S8 can be used irrespective of picture types. That is, in the case of I-Picture (Intraframe/Intrafield Coding Picture), the image complexity information S8 may be calculated depending upon frame data in the I-Picture. However, even in the case of P-Picture (Predictive Interframe/Interfield Coding Picture) or B-Picture (Both-way Predictive Interframe/Interfield Coding Picture), it is possible to use the image complexity information S8 obtained by the frame data in the I-Picture. As a matter of course, it is also possible to use another image complexity information S8 calculated depending upon frame data in the P-Picture or frame data in the B-Picture.

The quantization scale code transforming means 6 performs operations depending upon the quantization scale code data S5 and the post-recompression output data bulk information S15 such that a requantization scale value becomes the predetermined compressibility factor S16. Thereafter, the quantization scale code transforming means 6 transforms the requantization scale value, and outputs the result as the requantization scale code data S11. In this operation, the requantization scale value is calculated while an inclination is given to the coefficient according to the picture type, resulting in the effect of preventing degradation of image quality. The term “inclination” means that a smaller requantization scale value is set for the I-Picture, and requantization scale values are set to become greater in the order of the P-Picture and the B-Picture.

The header information delaying means 7 delays the header information required for decoding through the delaying means which can delay the header information by the time period required for the inverse quantization or the quantization of the DCT coefficient, and outputs the result as the header information S12 required for recompression. Meanwhile, the header information delaying means 7 may be omitted as long as the header information S12 can be output according to the MPEG 2 Coding format without the header information delaying means 7.

The quantizing means 8 divides the DCT coefficient data S7 by the requantization matrix data S10 and requantization scale code data obtained by transformation of the requantization scale code data S11, and creates and outputs the requantized DCT coefficient data S9.

The header information adding means 9 rearranges according to the MPEG 2 Coding format the requantized DCT coefficient data S9, the requantization matrix data S10, the requantization scale code data S11, and the header information S12 required for the recompression, resulting in producing and outputting the data S13.

The variable length encoding means 10 carries out the variable length encoding to output the result as the MPEG 2 stream data S14, and calculates and outputs the output data bulk information S15.

With the above series of operations, it is possible to utilize a feature of picture, and recompress the image to a desired amount of code without decoding the image pixel by pixel. It is thereby possible to perform the re-encoding at a higher speed than a normal play-back speed.

### Embodiment 2

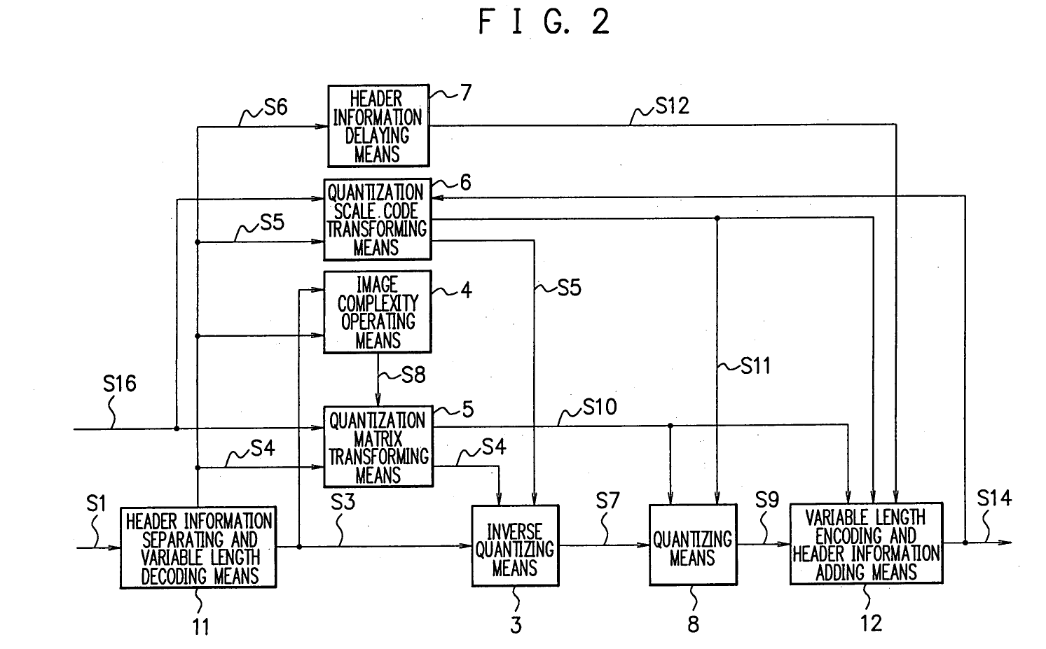

A description will now be given of the second embodiment of the present invention referring to FIG. 2. In FIG. 2, the same reference numerals are used for component parts identical with those shown in FIG. 1. In the second embodiment, header information separating and variable length decoding means 11 separates compressed/encoded image data S1 into a DCT coefficient S3, and other header information S4, S5, and S6.

An inverse quantizing means 3 calculates a quantization scale depending upon quantization matrix data S4 output from the quantization matrix transforming means 5 and quantization scale code data S5 output from the quantization scale code transforming means 6. Thus, DCT coefficient data S3 is requantized (multiplied) by the quantization scale so that the DCT coefficient data S7 is produced and output. In this case, the inverse quantizing means 3 has 64 preset DCT coefficients. However, since no processing is required when no image data is input, it is not essential to provide a constant amount of the DCT coefficient data S7.

The image complexity operating means 4 multiplies by a quantization scale obtained by transformation of the quantization scale code data S5 an amount of data of the DCT coefficient S3, thereby calculating image complexity information (X value) S8.

Depending upon a predetermined compressibility factor S16, the quantization matrix transforming means 5 changes quantization matrix data S4 in the compressed/encoded image data S1 to produce and output the result as requantization matrix data S10 having the effect of reducing higher frequency components in DCT components. In this operation, the requantization matrix data S10 may be varied according to the picture type, thereby providing an additional effect of reducing degradation in image quality. Specifically, if the type of an input image is I-Picture, the quantization matrix data may be set such that only partial higher components can take a great value. Further, in the case of P-Picture or B-Picture, the quantization matrix data may be changed in lower components.

A quantization scale code transforming means 6 takes as inputs the quantization scale code data S5 in the compressed/encoded image data S1, the predetermined compressibility factor S16, and recompressed/encoded data S14, and changes a quantization scale such that a size of the recompressed/encoded data S14 can be controlled by the predetermined compressibility factor S16, resulting in producing and outputting requantization scale code data S11. In this operation, the quantization scale code transforming means 6 changes the quantization scale code according to the type of picture of the compressed image data, thereby providing the effect of reducing propagation of degradation in image quality. For the above purpose, a control is made such that a transformation coefficient of the requantization scale can take a smaller value in the I-Picture, and can take greater values in the order of the P-Picture and the B-Picture. Further, even in the P-Picture and the B-Picture, the transformation coefficient may be changed according to the type of block such as an intramacro block, or a non-intramacro block. That is, the weighting may be made to the transformation coefficient of the requantization scale such that the transformation coefficient of the intramacro block can take a smaller value than that of the non-intramacro block. It is thereby possible to provide the effect of additionally preventing degradation in image quality.

A quantizing means 8 requantizes inverse-quantized DCT coefficient data S7 depending upon requantization matrix data S10 and requantization scale data obtained by transformation of requantization scale code data S11, and creates and outputs recompressed DCT coefficient data S9.

According to the MPEG 2 Coding order, a variable length encoding and header information adding means 12 carries out variable length encoding of the requantization matrix data S10, the requantization scale code data S11, header information S12, and the recompressed DCT coefficient data S9, resulting in outputting recompressed/encoded time-varying image data S14. The above operation enables changing of the amount of code of the image complexity information and the image information making use of the DCT coefficient. It is thereby possible to realize a high-speed re-encoding, and reduce degradation in image quality.

### Embodiment 3

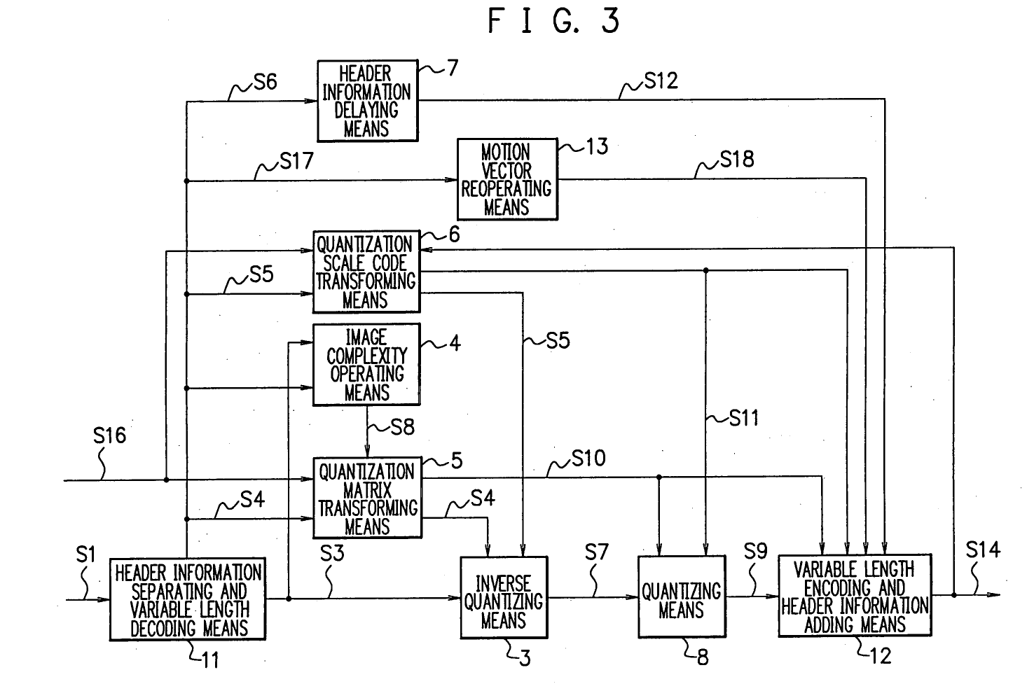

A description will now be given of the third embodiment of the present invention referring to FIG. 3. In the configuration, several functions are added to the configuration of the second embodiment. Specifically, a motion vector reoperating means 13 is additionally mounted, and a header information separating and variable length decoding means 11 is provided with the two functions of separating motion vector data S17, and of detecting redundant header information. In FIG. 3, the same reference numerals are used for component parts identical with those shown in FIGS. 1 and 2.

In the third embodiment, the header information separating and variable length decoding means 11 separates compressed/encoded image data S1 into a quantized DCT coefficient S3, quantization matrix data S4, quantization scale code S5, motion vector data S17, and other header information data S6. Further, the header information separating and variable length decoding means 11 has the function of deleting the redundant header information or stuffing information. The term “redundant header information” means that, for example, one slice contains a plurality of slice headers. If two or more slice headers are inserted into the slice, it is necessary to delete the second slice header or subsequent ones.

As set forth above, even when input data is the compressed/encoded image data S1 containing the redundant header information or the stuffing information, the header information separating and variable length decoding means 11 can delete the unnecessary information. Hence, it is possible to reduce an amount of information before reduction of the image information S3, resulting in reduction of deterioration in image quality. Meanwhile, for reduction of the header information, it may be necessary to recalculate the motion vector. In such a case, a motion vector reoperating means 13 performs reoperation of motion vector information to create and output post-reoperation motion vector data S18. Further, the post-reoperation motion vector data S18 may take a greater value than that of the input motion vector data S17, and may be greater than an amount of header information to be deleted. In such a case, the additional function may be provided to cancel reduction of the header information. The function allows a larger data area for the image information, resulting in reduction of deterioration in image quality.

According to the MPEG 2 Coding order, a variable length encoding and header information adding means 12 performs variable length encoding of requantization matrix data S10, requantization scale code data S11, header information S12, requantized DCT coefficient data S9, and the post-reoperation motion vector data S18, thereby creating and outputting recompressed/encoded image data S14.

Other means are operated as those in the second embodiment. Hence, as in the second embodiment, the operation enables changing of the amount of code of the image complexity information and the image information with the DCT coefficients. It is thereby possible to realize a high-speed re-encoding, and reduce deterioration in image quality.

Though preferred embodiments of the invention have been described according to the MPEG 2 Coding defined in ISO/IEC13818-2, such description is for illustrative purposes only. It is to be understood that the present invention can be applied to another coding method such as MPEG 4.

1. An image recompressing apparatus comprising:
variable length decoding means for performing variable length decoding of compressed/encoded image data;
header information separating means for separating header information and compressed image information from the compressed image data decoded by the variable length decoding means;
inverse quantizing means for requantizing the compressed image information depending upon a quantization matrix and a quantization scale code in the header information separated by the header information separating means;
quantization matrix transforming means for changing the quantization matrix according to a predetermined compressibility factor;
quantization scale code transforming means for changing the quantization scale code according to the compressibility factor;
quantizing means for requantizing the image information obtained by inverse quantization depending upon a post-transformation quantization matrix and a post-transformation quantization scale code; and
header information adding means for rearranging in the coding order the requantized image information, the header information, post-transformation quantization matrix information, and post-transformation quantization scale information.

2. The image recompressing apparatus according to claim 1, wherein the compressed/encoded image data is compressed/encoded according to an encoding method defined in ISO/IEC13818-2, and the compressed/encoded image information is a DCT coefficient.

3. An image recompressing apparatus comprising:
variable length decoding and header information separating means for performing variable length decoding depending upon header information of compressed/encoded image data, and separating the header information and DCT coefficient information from compressed image data obtained by the decoding;
inverse quantizing means for performing inverse quantization of the DCT coefficient information depending upon a quantization matrix and a quantization scale code separated by the variable length decoding and header information separating means to calculate a DCT coefficient;
quantization matrix transforming means for changing the quantization matrix according to a predetermined compressibility factor;
quantization scale code transforming means for changing the quantization scale code according to the compressibility factor;
quantizing means for requantizing the DCT coefficient obtained by the inverse quantization depending upon the post-transformation quantization matrix and the post-transformation quantization scale code; and
header information adding and variable length encoding means for performing in the encoding order variable length encoding of the requantized DCT coefficient information, the header information, the post-transformation quantization matrix information, and post-transformation quantization scale information to add the header information.

4. The image recompressing apparatus according to claim 3, wherein said quantization matrix transforming means transforms the quantization matrix to a quantization matrix value by weighting the quantization matrix to reduce high-frequency components in the DCT coefficient according to the predetermined compressibility factor or the picture type showing an encoding type of compressed/encoded image data, or according to the compressibility factor or the picture type.

5. The image recompressing apparatus according to claim 3, wherein said quantization scale code transforming means controls a transformation coefficient according to the predetermined compressibility factor and a picture type showing an encoding type of compressed/encoded image data.

6. The image recompressing apparatus according to claim 3, wherein said quantization matrix transforming means transforms the quantization matrix to a quantization matrix value by weighting the quantization matrix to reduce high-frequency components in the DCT coefficient according to the predetermined compressibility factor or a picture type showing an encoding type of compressed/encoded image data, or according to the compressibility factor or the picture type, and
said quantization scale code transforming means controls a transformation coefficient according to the predetermined compressibility factor and the picture type.

7. An image recompressing apparatus comprising:
variable length decoding and header information separating means for performing variable length decoding depending upon header information of compressed/encoded image data, and separating the header information and DCT coefficient information from compressed image data obtained by the decoding;
inverse quantizing means for performing inverse quantization of the DCT coefficient information depending upon a quantization matrix and a quantization scale code separated by the variable length decoding and header information separating means to calculate a DCT coefficient;
image complexity operating means for performing an operation depending upon the quantization scale code and the DCT coefficient information separated by the variable length decoding and header information separating means to produce image complexity information;
quantization matrix transforming means for changing the quantization matrix according to a predetermined compressibility factor and the image complexity information;
quantization scale code transforming means for changing the quantization scale code according to the compressibility factor;
quantizing means for requantizing the DCT coefficient obtained by the inverse quantization depending upon a post-transformation quantization matrix and a post-transformation quantization scale code; and
header information adding and variable length encoding means for performing variable length encoding in the encoding order requantized DCT coefficient information, header information, post-transformation quantization matrix information, and post-transformation quantization scale information.

8. The image recompressing apparatus according to claim 7, wherein the quantization matrix transforming means transforms the quantization matrix to a quantization matrix value by weighting the quantization matrix to reduce high-frequency components in the DCT coefficient according to the predetermined compressibility factor, the image complexity information, and a picture type showing an encoding type of the compressed/encoded image data.

9. The image recompressing apparatus according to claim 7, wherein said quantization scale code transforming means controls a transformation coefficient according to the predetermined compressibility factor, the image complexity information, and a picture type showing an encoding type of the compressed/encoded image data.

10. The image recompressing apparatus according to claim 7, wherein the quantization matrix transforming means transforms the quantization matrix to a quantization matrix value by weighting the quantization matrix to reduce high-frequency components in the DCT coefficient according to two pieces of information consisting of one of the predetermined compressibility factor or the image complexity information and a picture type showing an encoding type of the compressed/encoded image data, or three pieces of information consisting of the compressibility factor, the image complexity information, and the picture type, and
the quantization scale code transforming means controls a transformation coefficient according to the compressibility factor, the image complexity information, and the picture type showing the encoding type of the compressed/encoded image data.

11. An image recompressing apparatus comprising:
variable length decoding and header information separating means for performing variable length decoding depending upon header information of compressed/encoded image data, and separating the header information and DCT coefficient information from compressed image data obtained by the decoding;
inverse quantizing means for performing inverse quantization of the DCT coefficient information depending upon a quantization matrix and a quantization scale code separated by the variable length decoding and header information separating means to calculate a DCT coefficient;
image complexity operating means for performing an operation depending upon the quantization scale code and the DCT coefficient information separated by the variable length decoding and header information separating means to produce image complexity information;
quantization matrix transforming means for changing the quantization matrix according to a predetermined compressibility factor and the image complexity information;
quantization scale code transforming means for changing the quantization scale code according to the compressibility factor;
quantizing means for requantizing the DCT coefficient obtained by inverse quantization depending upon the post-transformation quantization matrix and the post-transformation quantization scale code;
header information delaying means for deleting, when redundant information is detected in the header information, a redundant component, and delaying the header information for a processing time period required for inverse quantization or requantization;
motion vector reoperating means for recalculating motion vector information; and
header information adding and variable length encoding means for performing variable length encoding in the encoding order the requantized DCT coefficient information, the delayed header information, the post-transformation quantization matrix information, the post-transformation quantization scale information, and the recalculated motion vector.

12. An image recompressing apparatus according to claim 11, wherein the quantization matrix transforming means transforms the quantization matrix to a quantization matrix value by weighting the quantization matrix to reduce high-frequency components in the DCT coefficient according to the predetermined compressibility factor, the image complexity information, and a picture type showing an encoding type of the compressed/encoded image data.

13. An image recompressing apparatus according to claim 11, wherein the quantization scale code transforming means controls a transformation coefficient according to the predetermined compressibility factor, and a picture type showing an encoding type of the compressed/encoded image data.

14. An image recompressing apparatus according to claim 11, wherein the quantization matrix transforming means transforms the quantization matrix to a quantization matrix value by weighting the quantization matrix to reduce high-frequency components in the DCT coefficient according to the predetermined compressibility factor, or the picture type showing an encoding type of the compressed/encoded image data, or the compressibility factor and the picture type, and
the quantization scale code transforming means controls a transformation coefficient according to the compressibility factor, and the picture type.

15. An image recompressing method comprising the steps of:
performing variable length decoding of compressed/encoded image data, and separating the header information and compressed image information from decoded compressed image data obtained by the decoding;
performing inverse quantization of the compressed image information depending upon a quantization matrix and a quantization scale code in the separated header information;
changing the quantization matrix according to a predetermined compressibility factor, changing the quantization scale code according to the compressibility factor, and requantizing the inverse-quantized compressed image information depending upon the post-transformation quantization matrix and the post-transformation quantization scale code; and
outputting in the encoding order the separated header information, the post-transformation quantization matrix, the post-transformation quantization scale code, and the requantized compressed image information.
